(19) United States
(12) Patent Application Publication
(10) Pub. No.: US 2018/0263036 A1
(43) Pub. Date: Sep. 13, 2018

(54) COMMUNICATING DEVICE AND ASSOCIATED METHOD APPLYING MULTIPLE PACKET DETECTORS

(71) Applicant: MEDIATEK INC., Hsin-Chu (TW)

(72) Inventors: Yung-En Hsieh, Taipei City (TW); Tsai-Yuan Hsu, Hsinchu County (TW); Ching-Yu Kuo, Hsinchu City (TW); Shun-Yong Huang, Hsinchu County (TW)

(21) Appl. No.: 15/451,423

(22) Filed: Mar. 7, 2017

(51) Int. Cl. H04W 72/04; H04W 28/02

(52) U.S. Cl. CPC H04W 72/0453; H04W 28/0231

(57) ABSTRACT

A communicating device includes: a first packet detector and a second packet detector, wherein the first detector is arranged to detect a first preamble included in a first response packet over a first sub-channel; and the second packet detector is arranged to detect a second preamble included in a second response packet over a second sub-channel. The second sub-channel is different from the first sub-channel, and the first packet detector and the second packet detector co-exist in the communicating device.

### BACKGROUND

The present invention relates to a wireless communication device, and more particularly, to a communicating device applying multiple packet detectors to scan channels, and an associated method.

In order for a station (STA) to find an appropriate network to join or for the STA to set up a network on a channel, it is usually required to scan through all 2.4G/5G channels by sequentially sending probe requests. As there are nearly 40 channels in the 2.4G/5G domain, it will take a long time for a station to discover all of networks.

### SUMMARY

One of the objectives of the present invention is to provide a communicating device and an associated method to solve the abovementioned problem.

According to an embodiment of the present invention, a communicating device is disclosed, comprising: a first packet detector, arranged to detect a first preamble included in a first response packet over a first sub-channel; and a second packet detector, arranged to detect a second preamble included in a second response packet over a second sub-channel; wherein the second sub-channel is different from the first sub-channel, and the first packet detector and the second packet detector co-exist in the communicating device.

According to an embodiment of the present invention, a communicating method is disclosed, comprising: performing a first packet detection to detect a first preamble included in a first response packet over a first sub-channel; and performing a second packet detection to detect a second preamble included in a second response packet over a second sub-channel; wherein the second sub-channel is different from the first sub-channel, and the first packet detection and the second packet detection are not performed by a same packet detector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating channel cover in response to different channel widths.

FIG. 2 is a diagram illustrating a communicating device according to an embodiment of the present invention.

FIG. 3 is a diagram illustrating a radio frequency device according to an embodiment of the present invention.

FIG. 4 is a diagram illustrating a channel bonding applied by the transmitter according to an embodiment of the present invention.

FIG. 5 is a diagram illustrating the packet detectors and the decoders covering the channels according to an embodiment of the present invention.

FIG. 6 is a diagram illustrating the packet detectors and the decoders covering the channels according to another embodiment of the present invention.

FIG. 7 is a flowchart illustrating an operation of the communicating device applying multiple packet detectors according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

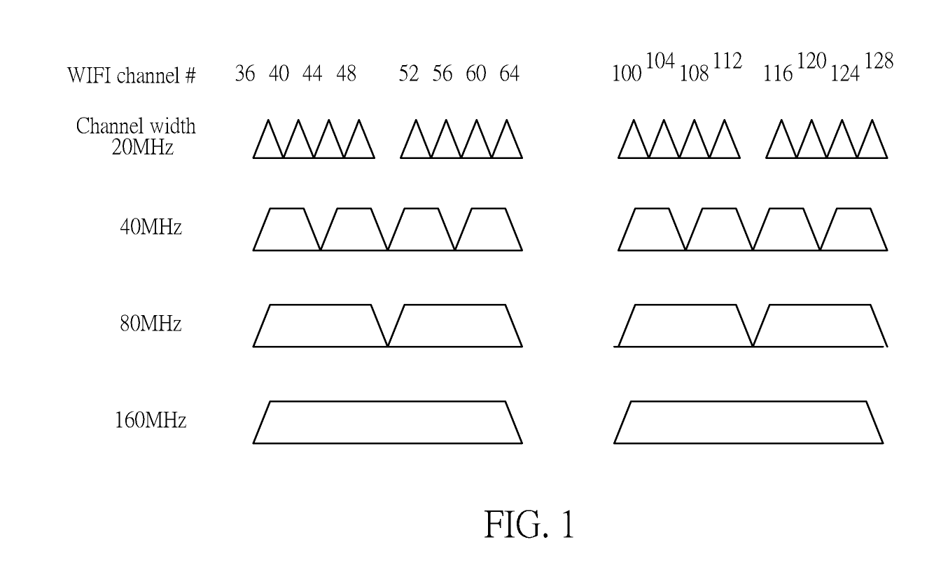

FIG. 1 is a diagram illustrating channel cover in response to different channel widths. As shown in FIG. 1, according to a channel width set for a radio frequency (RF) circuit, the RF circuit can cover different numbers of channels at one time in order to detect if there is any access point on those channels. For example, when the channel width of the RF circuit is set to be 20 MHz, only one channel is covered at one time for the RF circuit to detect if there is an access point on that channel. When the channel width of the RF circuit is set to be 40 MHz, two channels are covered at one time for the RF circuit to detect if there is an access point on those channels. When the channel width of the RF circuit is set to be 80 MHz, four channels are covered at one time for the RF circuit to detect if there is an access point on those channels. When the channel width of the RF circuit is set to be 160 MHz, eight channels are covered at one time for the RF circuit to detect if there is an access point on those channels.

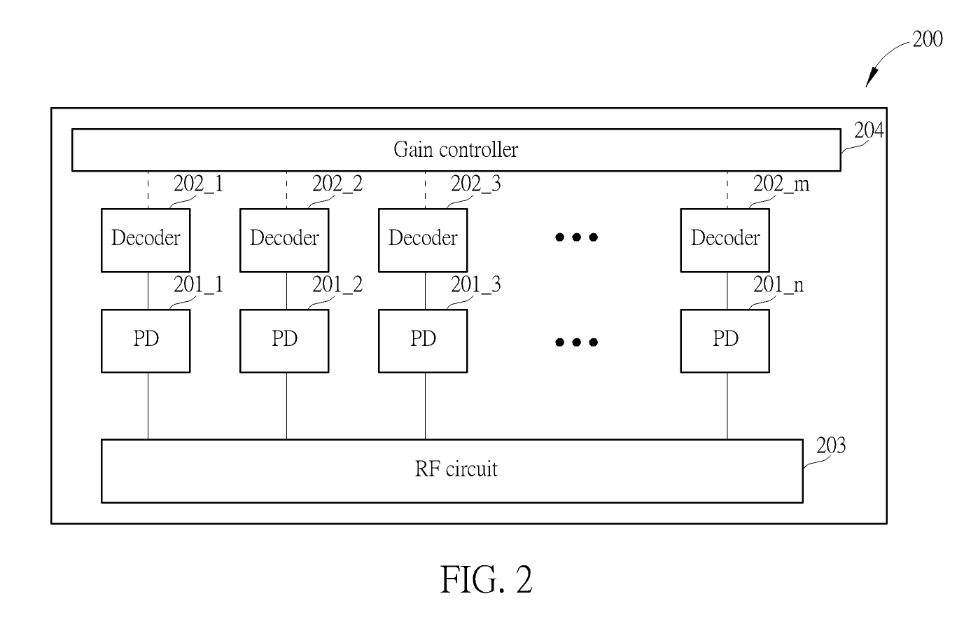

FIG. 2 is a diagram illustrating a communicating device 200 according to an embodiment of the present invention. As shown in FIG. 2, the communicating device 200 comprises packet detectors (PDs) 201_1-201_n, decoders 202_1-202_m, an RF circuit 203, and a gain controller 204. The PDs 201_1-201_n installed therein are able to scan n channels at one time, wherein n is a positive integer. The decoders 202_1-202_m corresponding to the PDs 201_1-201_n are arranged for decoding Wi-Fi response packets (each comprising a probe response or a beacon) received from access points, wherein m is also a positive integer.

The gain controller 204 is arranged to adjust the power of the Wi-Fi response packets or beacons received from the access points over the channels to prevent the power of received signals (or packets) from being too high and affecting the decoding correctness of the signals on adjacent channels. It should be noted that the number n of the PDs is based on the channel width of the RF circuit 203 of the communicating device 200 which is set before the communication. As mentioned above, when the channel width of the RF circuit 203 of the communicating device 200 is set to be 160 MHz, eight channels are covered at one time. Therefore, with eight PDs (i.e. n=8) installed in the communicating device 200 and a proper number of decoders, the communicating device 200 can receive and decode Wi-Fi response packets from the access points over eight different channels. In other embodiments, when the channel width of the RF circuit 203 of the communicating device 200 is set to be more or less than 160 MHz resulting in more or fewer channels being covered at one time, the number of the PDs installed therein can also be adjusted accordingly to scan those channels at one time. For simplicity and clarity, in the following paragraphs, the channel width of the RF circuit 203 disclosed by the present invention is set to be 160 MHz to scan eight channels at one time; namely, n=8.

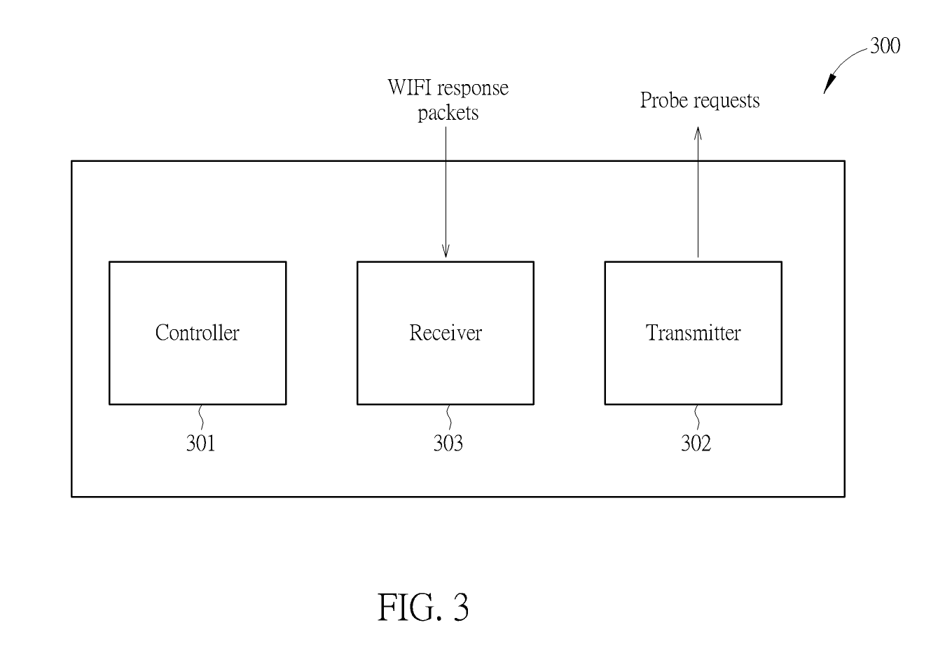

FIG. 3 is a diagram illustrating the RF circuit 203 according to an embodiment of the present invention. As shown in FIG. 3, the RF circuit 203 comprises a controller 301, a transmitter 302 and a receiver 303. The controller 301 is arranged to set the channel width of the RF circuit 203. The transmitter 302 is arranged to transmit probe requests to discover access points over eight channels. The receiver 303 is arranged to receive Wi-Fi response packets (each comprising a probe response or a beacon corresponding to the probe request) from those access points which previously received the probe requests via the corresponding PD. FIG. 2 illustrates this process. After the transmitter transmits probe requests over eight channels, if there are eight access points on the eight channels receiving the probe request and sending back the WIFI response packets over the eight channels, the receiver 303 can receive all the Wi-Fi response packets via the PDs 201_1-201_n (n=8).

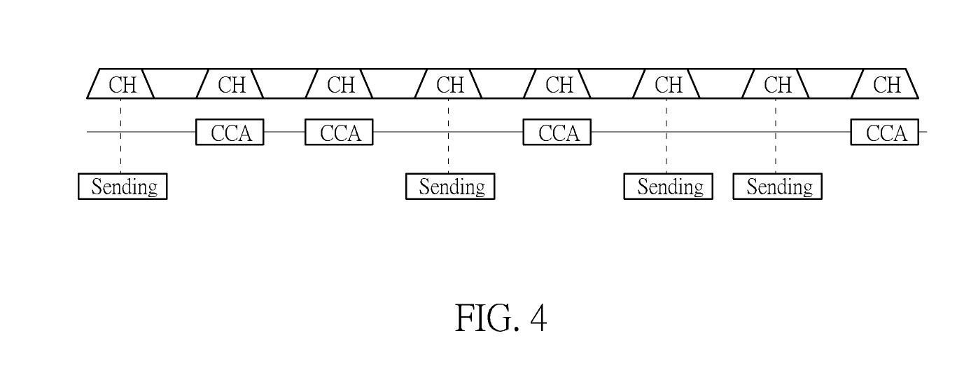

The transmitter 302 further utilizes a channel bonding technique to transmit the probe requests. FIG. 4 is a diagram illustrating a channel bonding applied by the transmitter 302 according to an embodiment of the present invention. As shown in FIG. 4, eight channels (marked “CH” in FIG. 4) can be covered at one time when the channel width of the RF circuit 203 is set to be 160 MHz. When a channel is occupied, a clear channel assessment (CCA) is generated to indicate the occupation. The transmitter will then stop transmitting a probe request over the occupied channel until the CCA disappears. For example, as shown in FIG. 4, four channels show CCAs to indicate the occupation. The transmitter 302 therefore transmits probe requests over the other four channels, and stops transmitting the probe requests over the four occupied channels until the CCAs disappear. The probe requests transmitted by the transmitter 302 can carry some information indicating the targeted received power of the Wi-Fi response packets, which the access points will then transmit back to the communicating device 200 after receiving the probe requests. By requiring the proper received power of the Wi-Fi response packets, the decoding correctness of the received signals can be assured.

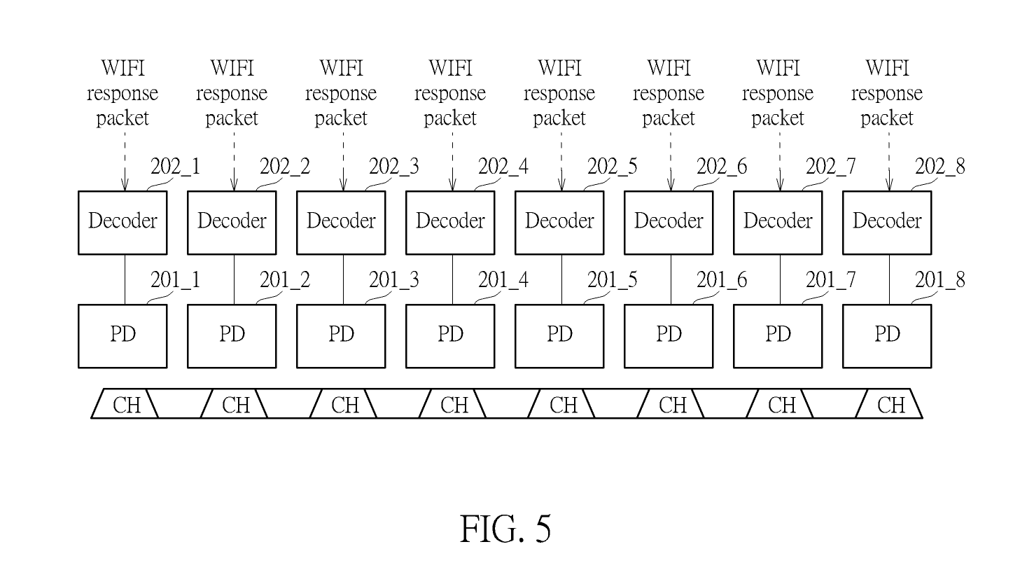

As mentioned above, when the channel width of the RF circuit 203 is set to be 160 MHz, eight channels are covered at one time. Therefore, with eight PDs (i.e. n=8), the communicating device 200 can scan eight channels at one time. The decoders 202_1-202_m, however, are not limited to be one-to-one or multiple-to-one against the PDs 201_1-201_n, i.e. m can be either equal to n or not. FIG. 5 is a diagram illustrating the packet detectors 201_1-201_n and the decoders 202_1-202_m covering the channels according to an embodiment of the present invention, wherein the channel width of the RD circuit 203 is set to be 160 MHz, and n=m=8. After the transmitter 302 of the RF circuit 203 transmits probe requests over eight channels with the PDs 201_1-201_n (n=8) and the decoder 202_1-202_m (m=8), the communicating device 200 is able to receive and decode eight Wi-Fi response packets from eight access points over eight channels at one time. In other words, the communicating device 200 is able to scan eight channels at one time. When the current eight channels have completed scanning, the communicating device 200 can scan a next eight channels at one time. This can greatly reduce the scanning time for discovering access points.

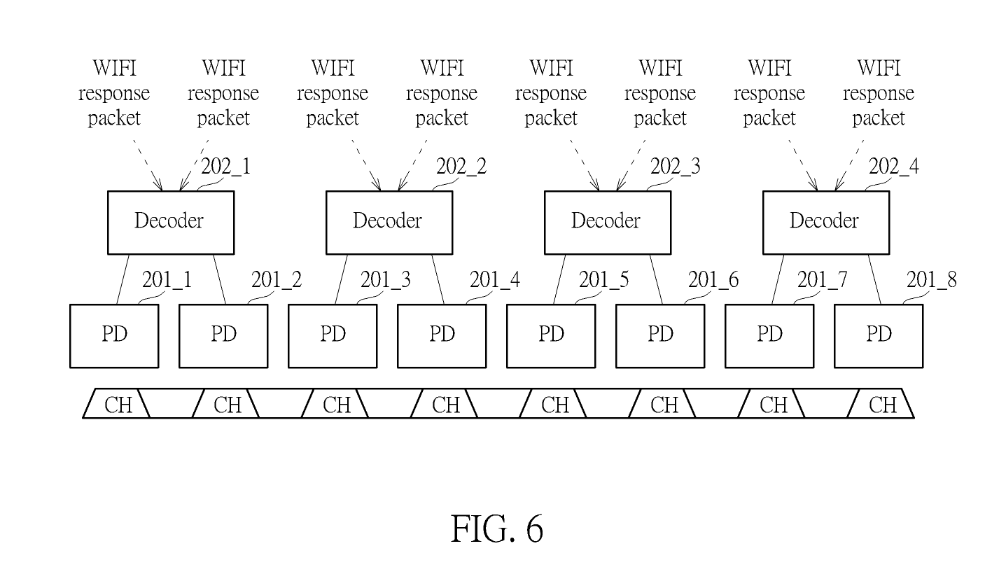

As mentioned above, the transmitter 302 transmits probe requests with the channel bonding technique. The time for transmitting probe requests over different channels may not be simultaneous when any channel shows the CCA, and the communicating device 200 will therefore not receive Wi-Fi response packets simultaneously from access points. Due to this slight time difference, the decoders are not required to be one-to-one against the PDs in actual application. FIG. 6 is a diagram illustrating the packet detectors 201_1-201_n and the decoders 202_1-202_m covering the channels according to another embodiment of the present invention, wherein the channel width of the RD circuit 203 is set to be 160 MHz, and n=8 while m=4. As shown in FIG. 6, two of the PDs 201_1-201_n co-ordinate with one decoder. After the transmitter 302 of the RF circuit 203 transmits probe requests over eight channels with a slight time difference using the PDs 201_1-201_n (n=8) and the decoder 202_1-202_m (m=4), the communicating device 200 can still receive and decode eight Wi-Fi response packets from eight access points over eight channels. In other words, the communicating device 200 is able to scan eight channels at one time. When the current eight channels have completed scanning, the communicating device 200 can scan a next eight channels at one time. This can greatly reduce the scanning time for discovering access points.

Briefly summarized, the RF circuit disclosed by the present invention can detect access points over multiple channels by performing packet detections over the multiple channels, wherein multiple packet detectors are installed so the packet detections are not performed by a same packet detector.

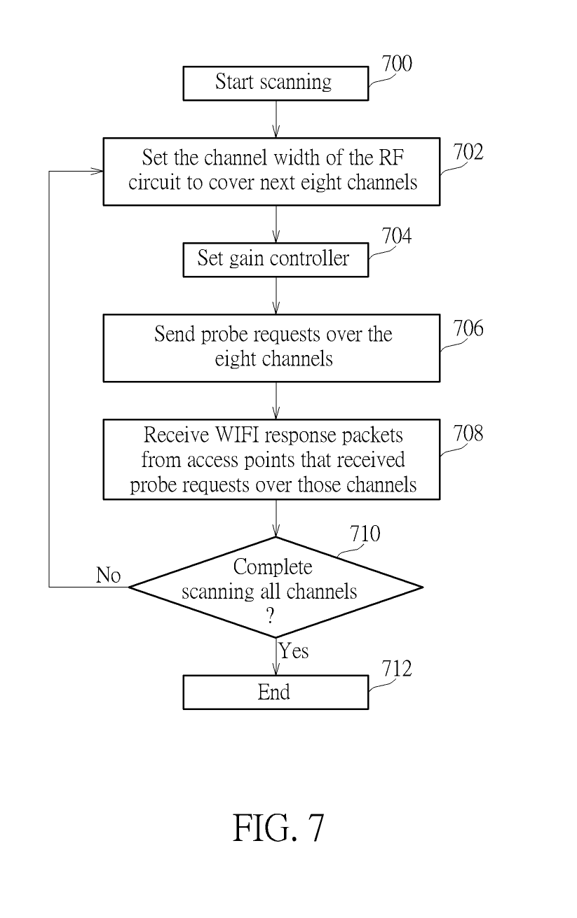

FIG. 7 is a flowchart illustrating an operation of the communicating device 200 applying multiple packet detectors 201_1-201_n according to an embodiment of the present invention. It should be noted that the channel width of the RF circuit in the embodiment of FIG. 7 is set to be 160 MHz, i.e. the communicating device 200 comprising PDs 201_1-201_8 can cover eight channels at one time. Those skilled in the art should readily understand, however, that the number of PDs comprised in the communicating device 200 can be adjusted according to the channel width of the RF circuit. The operation is summarized in the following steps. Provided that the result is substantially the same, the steps are not required to be executed in the exact order shown in FIG. 7.

Step 700: start scanning.
Step 702: set the channel width of the RF circuit to cover a next eight channels.
Step 704: set gain controller.
Step 706: send probe requests over the eight channels.
Step 708: receive Wi-Fi response packets from access points that have received probe requests before.
Step 710: has scanning of all channels been completed? If yes, to go step 712; otherwise, go to step 702.

### Step 712: end.

Those skilled in the art should readily understand the detail of each step shown in FIG. 7 after reading the above embodiments.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communicating device, comprising:
a first packet detector, arranged to detect a first preamble included in a first response packet over a first sub-channel; and
a second packet detector, arranged to detect a second preamble included in a second response packet over a second sub-channel;
wherein the second sub-channel is different from the first sub-channel, and the first packet detector and the second packet detector co-exist in the communicating device.

2. The communicating device of claim 1, wherein the first packet detector and the second detector detect the first response packet and the second response packet by decoding the first response packet and the second response packet via at least one decoder.

3. The communicating device of claim 2, wherein the decoder comprises a first decoder and a second decoder, the first decoder couples to the first packet detector and decodes the first response packet, and the second decoder couples to the second packet detector and decodes the second response packet.

4. The communicating device of claim 1, further comprising:
a transmitter, arranged to transmit a first communication request over the first sub-channel, and transmit a second communication request over the second sub-channel;
wherein the first packet detector detects the first response packet corresponding to the first communication request after the first communication request is transmitted, and the second packet detector detects the second response packet corresponding to the second communication request after the second communication request is transmitted.

5. The communicating device of claim 4, wherein before the first communication request is transmitted, the transmitter determines if the first sub-channel is marked by a first indicator.

6. The communicating device of claim 5, wherein when the transmitter determines the first sub-channel is marked by the first indicator, the transmitter stops transmitting the first communication request until the first indicator disappears.

7. The communicating device of claim 6, wherein the first indicator is a clear channel assessment (CCA).

8. The communicating device of claim 4, wherein the first communication request comprises a first information indicating a preferred received power for the first response packet.

9. The communicating device of claim 1, further comprising:
a gain controller, coupled to the first packet detector and the second packet detector, arranged to adjust a power of the first response packet and a power of the second response packet.

10. The communicating device of claim 1, further comprising:
a controller, arranged to set a channel bandwidth of the communicating device to cover the first sub-channel and the second sub-channel to make the communicating device communicate over the first sub-channel and the second sub-channel.

11. A communicating method, comprising:
performing a first packet detection to detect a first preamble included in a first response packet over a first sub-channel; and
performing a second packet detection to detect a second preamble included in a second response packet over a second sub-channel;
wherein the second sub-channel is different from the first sub-channel, and the first packet detection and the second packet detection are not performed by a same packet detector.

12. The communicating method of claim 11, wherein the first response packet and the second response packet are detected by decoding the first response packet and the second response packet via at least one decoder.

13. The communicating method of claim 12 wherein the decoder comprises a first decoder and a second decoder, the first decoder decodes the first response packet, and the second decoder decodes the second response packet.

14. The communicating method of claim 11, further comprising:
transmitting a first communication request over the first sub-channel; and
transmitting a second communication request over the second sub-channel;
wherein the first packet detection detects the first response packet corresponding to the first communication request after the first communication request is transmitted, and the second packet detection detects the second response packet corresponding to the second communication request after the second communication request is transmitted.

15. The communicating method of claim 14, further comprising:
determining if the first sub-channel is marked by a first indicator before the first communication request is transmitted.

16. The communicating method of claim 15, further comprising:
stopping transmitting the first communication request until the first indicator disappears when the first sub-channel is marked by the first indicator.

17. The communicating method of claim 16, wherein the first indicator is a clear channel assessment (CCA).

18. The communicating method of claim 14, wherein the first communication request comprises a first information indicating a preferred received power for the first response packet.

19. The communicating method of claim 11, further comprising:
adjusting a power of the first response packet and a power of the second response packet.

20. The communicating method of claim 11, wherein the communicating method is employed by a communicating device, and further comprises:
setting a channel bandwidth of the communicating device to cover the first sub-channel and the second sub-channel to make the communicating device communicate over the first sub-channel and the second sub-channel.
